(19) United States
(12) Patent Application Publication
(10) Pub. No.: US 2026/0255446 A1
(43) Pub. Date: Aug. 27, 2026

(54) Graphene Heater

(71) Applicant: Youhe Electric Appliances (Jiangsu) Co., Ltd., Yancheng (CN)

(72) Inventor: Gang Lei, Yancheng (CN)

(21) Appl. No.: 19/001,057

(22) Filed: Dec. 24, 2024

(51) Int. Cl. H05B 3/14; H05B 3/50

(52) U.S. Cl. CPC H05B 3/145; H05B 3/50; H05B 2203/013

(57) ABSTRACT

A graphene heater, comprising a heat conductor and/or a heating element. In Embodiment 1, the heat conductor is an electric conductor provided at both ends of a ceramic heating plate and a heat sink provided between the electric conductors; surfaces of the electric conductor and the heat sink facing a heat outlet are provided with a graphene coating. In Embodiment 2, the heating element is an electric heating wire wound around a mica sheet; a surface of the electric heating wire is provided with a graphene coating. In embodiment 3, the heating element is an infrared heating tube; the infrared heating tube comprises a high temperature resistant glass tube; an outer surface of the high temperature resistant glass tube is provided with a graphene coating. In embodiment 4, the heat conductor is a heat dissipation fin, and the heating element is an electric heating tube.

### TECHNICAL FIELD

The invention related to the technical field of heaters, and in particular to a heater using graphene technology.

### BACKGROUND ART

The convection heaters in the prior art mainly transfer heat through air convection, so the strength of convection affects the user's heating experience. Heaters with weaker convection effects have higher temperatures near the heater and lower temperatures slightly farther away from the heater. Heaters with stronger convection effects have higher temperatures in the convection area and lower temperatures in other areas. However, no matter which type of convection heater, none of them has the advantages of fast heating speed and good comfort of radiant heaters.

### SUMMARY OF THE INVENTION

The invention provides a graphene coating on the surface of the heat conductor or heating element, so that the infrared radiation intensity of the heat conductor or heating element is enhanced. Therefore, the heat conductor or heating element combines the advantages of a convection heating element and a radiation heating element, and has a strong infrared radiation intensity while conducting heat through convection.

In order to solve the above technical problems, the invention provides a graphene coating on the surface of the heat conductor or the heat generator.

In Embodiment 1, the heat conductor is an electric conductor provided at both ends of a ceramic heating plate and a heat sink provided between the electric conductors;

surfaces of the electric conductor and the heat sink facing a heat outlet are provided with a graphene coating.

In Embodiment 2, the heating element is an electric heating wire wound around a mica sheet。

Further, the cross-sectional shape of the electric heating wire is oblate;

Further, a longer side of the cross section of the electric heating wire is arranged perpendicular to the heat outlet, and a shorter side thereof is arranged parallel to the heat outlet.

In Embodiment 3, the heating element is an infrared heating tube.

The infrared heating tube comprises a high temperature resistant glass tube; an outer surface of the high temperature resistant glass tube is provided with a graphene coating

In Embodiment 4, the heat conductor is a heat dissipation fin, and the heating element is an electric heating tube; a metal shell is provided outside the heat dissipation fins and the electric heating tube.

Further, a front panel of the metal shell is provided with radiation holes.

Further, one end of the heat dissipation fin is provided with a radiation plate.

Further, a surface of the radiation plate facing the radiation holes is provided with a graphene coating.

Preferably, the radiation plate is arranged parallel to the radiation holes.

Further, the electric heating tube comprises a first heating tube and a second heating tube.

Preferably, the second heating tube is arranged vertically relative to the first heating tube.

Preferably, the electric heating tube is arranged close to the radiation holes.

### BRIEF DESCRIPTION OF THE DRAWINGS

FIG. 1 is a schematic diagram of the graphene PTC heater in Embodiment 1 according to the invention.

FIG. 2 is a schematic diagram of the graphene PTC heating element in Embodiment 1 according to the invention.

FIG. 3 is a cross-sectional view of the graphene PTC heating element in Embodiment 1 according to the invention taken along line A-A.

FIG. 4 is a schematic diagram of the graphene electric heating wire heater in Embodiment 2 according to the invention.

FIG. 5 is a schematic diagram of the graphene heating wire heating element in Embodiment 2 according to the invention.

FIG. 6 is a cross-sectional view of the graphene heating wire heating element in Embodiment 2 according to the invention taken along line A-A.

FIG. 7 is a schematic cross-sectional view of the graphene heating wire in Embodiment 2 according to the invention.

FIG. 8 is a schematic diagram of the graphene infrared heater in Embodiment 3 according to the invention.

FIG. 9 is a schematic diagram of the graphene infrared heating tube in Embodiment 3 according to the invention.

FIG. 10 is a cross-sectional view of the graphene infrared heating tube in Embodiment 3 according to the invention taken along line A-A.

FIG. 11 is a schematic diagram of the graphene skirting heater according in Embodiment 4 according to the invention.

FIG. 12 is a schematic diagram of the graphene electric heating tube in Embodiment 4 according to the invention.

FIG. 13 is a cross-sectional view of the graphene electric heating tube in Embodiment 4 according to the invention taken along line A-A.

In the figures: 1 refers to the heat conductor; 11 refers to the electric conductor; 12 refers to the heat sink; 13 refers to the heat dissipation fin; 131 refers to the radiation plate; 14 refers to the metal shell; 140 refers to the front panel; 141 refers to the radiation hole; 2 refers to the heating element; 20 refers to the ceramic heating plate; 21 refers to the electric heating wire; 211 refers to the longer side of the cross section; 212 refers to the shorter side of the cross section; 22 refers to the infrared heating tube; 221 refers to the high temperature resistant glass tube; 23 refers to the electric heating tube; 231 refers to the first electric heating tube; 232 refers to the second electric heating tube; 3 refers to the graphene coating; 4 refers to the mice plate; 5 refers to the heat outlet; 6 refers to the radiation port.

### SPECIFIC EMBODIMENT OF THE INVENTION

The invention will be further described hereinafter with reference to the drawings and specific embodiments so that those skilled in the art can better understand the invention and implement it, but the embodiments are not intended to limit the invention.

In the description of the invention, it needs to be understood that the orientation or positional relationship indicated by the terms “vertical”, “horizontal”, “inner”, “outer”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention.

In addition, the terms "first" and "second" are used for descriptive purposes only and should not be understood as indicating or implying relative importance or implicitly indicating the number of technical features indicated. Thus, the features defined as "first" and "second" may explicitly or implicitly include at least one of the features.

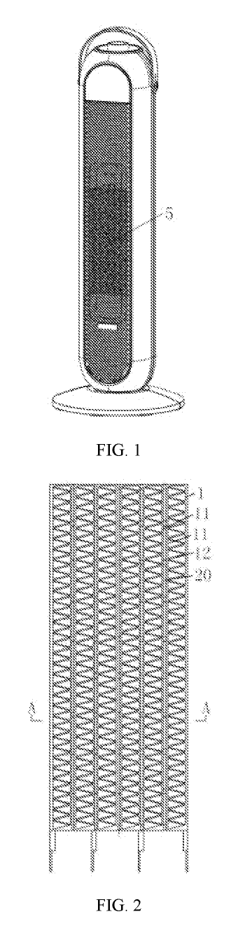

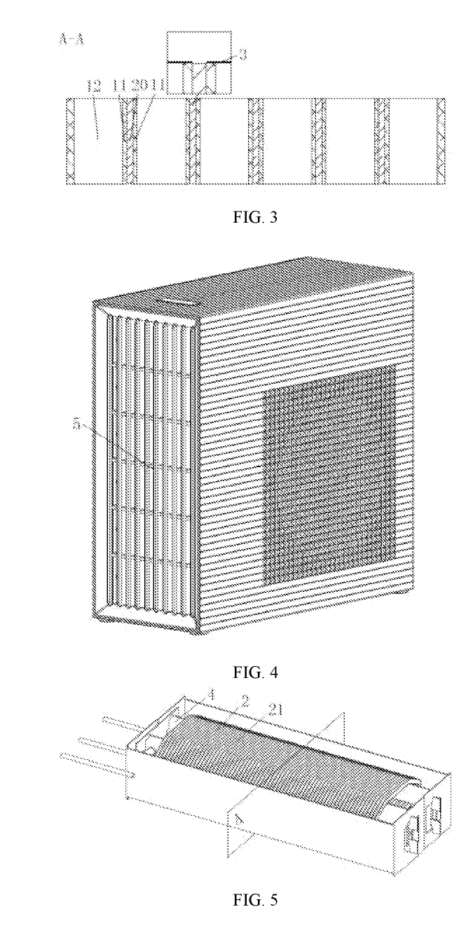

With reference to FIGS. 1-3, an Embodiment 1 of the graphene heater according to the invention, comprising a heat conductor 1. The heat conductor 1 is an electric conductor 11 provided at both ends of a ceramic heating plate 20 and a heat sink 12 provided between the electric conductors. Surfaces of the electric conductor 11 and the heat sink 12 facing a heat outlet are provided with a graphene coating 3.

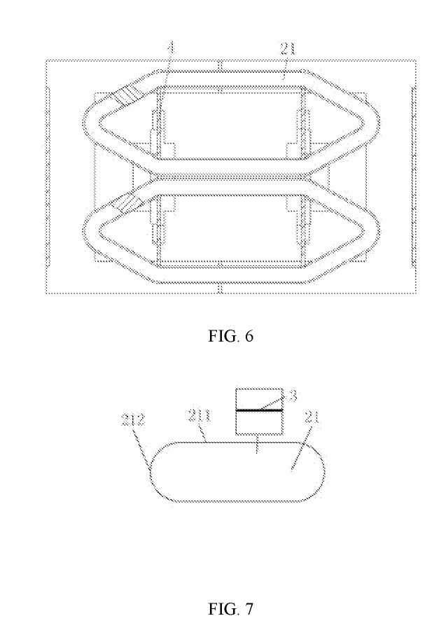

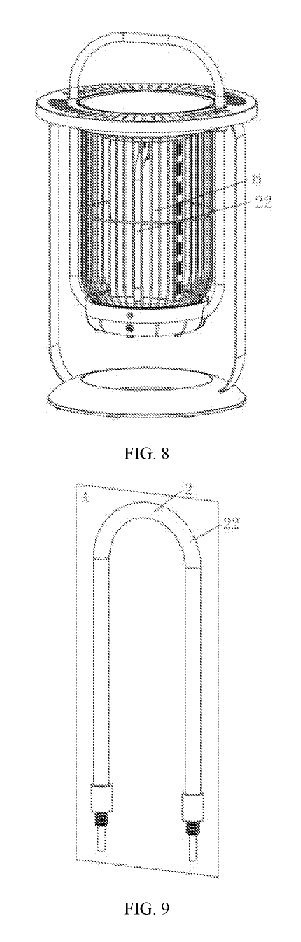

With reference to FIGS. 4-7, an Embodiment 2 of the graphene heater according to the invention, comprising a heating element 2. The heating element 2 is an electric heating wire 21 wound around a mica sheet 4. The cross-sectional shape of the electric heating wire 21 is oblate. A surface of the electric heating wire 21 is provided with a graphene coating 3. A longer side 211 of the cross section of the electric heating wire 21 is arranged perpendicular to the heat outlet 5, and a shorter side 212 thereof is arranged parallel to the heat outlet 5.

The graphene coating 3 in Embodiment 1 and Embodiment 2 emits infrared radiation outward through the heat outlet 5 of the heater.

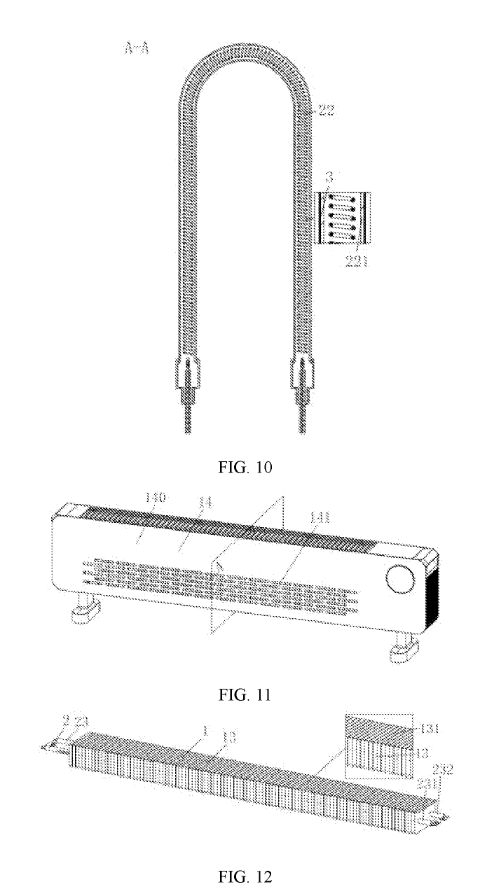

With reference to FIGS. 8-10, an Embodiment 3 of the graphene heater according to the invention, comprising a heating element 2. The heating element 2 is an infrared heating tube 22. The infrared heating tube 22 comprises a high temperature resistant glass tube 221. An outer surface of the high temperature resistant glass tube 221 is provided with a graphene coating 3.

The graphene coating 3 in Embodiment 3 emits infrared radiation outward through the radiation port 6 of the heater.

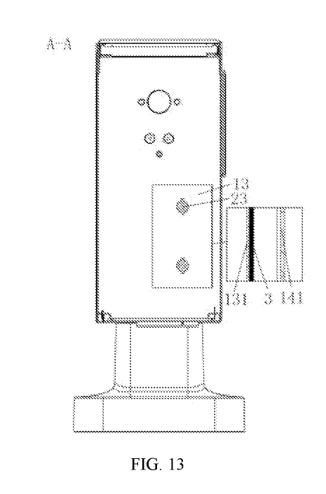

With reference to FIGS. 11-13, an Embodiment 4 of the graphene heater according to the invention, comprising a heat conductor 1 and a heating element 2. The heat conductor 1 is a heat dissipation fin 13, and the heating element 2 is an electric heating tube 23. A metal shell 14 is provided outside the heat dissipation fins 13 and the electric heating tube 23. A front panel 140 of the metal shell 14 is provided with radiation holes 141. One end of the heat dissipation fin 13 is provided with a radiation plate 131. A surface of the radiation plate 131 facing the radiation holes 141 is provided with a graphene coating 3. The electric heating tube 23 comprises a first heating tube 231 and a second heating tube 232. The second heating tube 232 is arranged vertically relative to the first heating tube 231. The electric heating tube 23 is arranged close to the radiation holes 141.

The graphene coating 3 on the radiation plate 131 in Embodiment 4 emits infrared radiation outward through the radiation holes 141.

By using a thermal imager with a model of HM-TPK10-3AQF/W, the surface temperature of the heat conductor or heating element is compared and tested.

In Embodiment 1, the maximum temperature of the electric conductor and heat sink without graphene spraying is 208.3℃, and the maximum temperature of the electric conductor and heat sink sprayed with graphene is 241.6℃. According to the Stefan-Boltzmann law and the normal emissivity of the material, the radiation emittance of the electric conductor and heat sink sprayed with graphene in the infrared band is increased by 1127.9%.

In Embodiment 2, the maximum temperature of the electric heating wire without graphene spraying is 227.4℃, and the maximum temperature of the electric heating wire sprayed with graphene is 420℃. According to the Stefan-Boltzmann law and the normal emissivity of the material, the radiation emittance of the electric heating wire sprayed with graphene in the infrared band is increased by 1507.7%.

In Embodiment 3, the maximum temperature of the infrared heating tube without graphene spraying is 335.8℃, and the maximum temperature of the infrared heating tube sprayed with graphene is 395.5℃. According to the Stefan-Boltzmann law and the normal emissivity of the material, the radiation emittance of the infrared heating tube sprayed with graphene in the infrared band is increased by 25.8%.

In Embodiment 4, the maximum temperature of the heat dissipation fin without graphene spraying is 326.1℃, and the maximum temperature of the heat dissipation fin sprayed with graphene is 360.5℃. According to the Stefan-Boltzmann law and the normal emissivity of the material, the radiation emittance of the heat dissipation fin sprayed with graphene in the infrared band is increased by 1114.3%.

The above embodiments are only preferred embodiments for fully illustrating the invention, and the protection scope of the invention is not limited thereto. Equivalent substitutions or changes made by technicians in the technical field on the basis of the invention are all within the protection scope of the invention. The protection scope of the invention shall be subject to the claims.

1. A graphene heater, comprising a heat conductor and/or a heating element.

2. The graphene heater of claim 1, wherein the heat conductor is an electric conductor provided at both ends of a ceramic heating plate and a heat sink provided between the electric conductors; surfaces of the electric conductor and the heat sink facing a heat outlet are provided with a graphene coating.

3. The graphene heater of claim 1, wherein the heating element is an electric heating wire wound around a mica sheet; the cross-sectional shape of the electric heating wire is oblate; a surface of the electric heating wire is provided with a graphene coating.

4. The graphene heater of claim 3, wherein a longer side of the cross section of the electric heating wire is arranged perpendicular to the heat outlet, and a shorter side thereof is arranged parallel to the heat outlet.

5. The graphene heater of claim 1, wherein the heating element is an infrared heating tube; the infrared heating tube comprises a high temperature resistant glass tube; an outer surface of the high temperature resistant glass tube is provided with a graphene coating.

6. The graphene heater of claim 1, wherein the heat conductor is a heat dissipation fin, and the heating element is an electric heating tube; a metal shell is provided outside the heat dissipation fins and the electric heating tube; a front panel of the metal shell is provided with radiation holes.

7. The graphene heater of claim 6, wherein one end of the heat dissipation fin is provided with a radiation plate; a surface of the radiation plate facing the radiation holes is provided with a graphene coating.

8. The graphene heater of claim 7, wherein the radiation plate is arranged parallel to the radiation holes.

9. The graphene heater of claim 8, wherein the electric heating tube comprises a first heating tube and a second heating tube; the second heating tube is arranged vertically relative to the first heating tube.

10. The graphene heater of claim 9, wherein the electric heating tube is arranged close to the radiation holes.
